(19) United States
(12) Patent Application Publication
(10) Pub. No.: US 2012/0076437 A1
(43) Pub. Date: Mar. 29, 2012

(54) SYSTEM AND METHOD FOR AUTOMATED CLAIMS PROCESSING

(75) Inventor: Daniel A. King, Austin, TX (US)

(73) Assignee: DigiClaim, Inc.

(21) Appl. No.: 13/221,829

(22) Filed: Aug. 30, 2011

Related U.S. Application Data
(63) Continuation-in-part of application No. 10/005,795, filed on Nov. 8, 2001, now abandoned.

(51) Int. Cl. G06K 9/36; G06K 7/10

(52) U.S. Cl. 382/286; 382/321

(57) ABSTRACT

A claims and repair process including collecting accident information at birth of an accident, electronic communication to a remote site, and posting information for selecting repair and supplier parties, such as by a bid process. Any of a PDA, a mapping system, or a data collection system installed on the vehicle collects accident information at the accident site, on a tow truck, or at a facility. A PDA with a digital camera may be provided for collecting digital images. Wireless communications may be used to transfer accident information for expedited processing. A claims estimate may be made by a claims adjuster or claims wizard. An aggregate database may be employed by the claims wizard to facilitate damage assessment. The claims wizard may work interactively with a PDA device for improved data collection. Tow trucks may be dispatched to transport rental, damaged and repaired vehicles to reduce insured's involvement.

### CROSS-REFERENCE TO RELATED APPLICATIONS

This application is a continuation-in-part of U.S. patent application Ser. No. 10/005,795, which is incorporated by reference in its entirety herein.

### FIELD

The present invention relates to claims processing, and more particularly, to expediting the claims process for any industry, such as automobile insurance, civil engineering, public works, construction, fraud prevention, security, traffic enforcement, shipping, inventory control, etc., where an inspection, comparison, verification or observation process occurs.

### BACKGROUND

In 1896, there were only four cars registered in all of the United States. Two of them collided with each other in St. Louis, Mo. The IMF forecasts that the world will have nearly 3 billion cars in 2050, compared with 700M today. As of 2008, in the U.S. market, there are approximately 300M insured personal and fleet vehicles and approximately 18M accidents per year. This U.S. collision industry is a $55B market space, of which $12B alone are adjustment expenses due to inefficient systems and processes. In addition to the U.S. market, the Western European market space has approximately $13B of adjustment expenses in a market space of nearly $60B. These expenses are trending up in both markets. The legacy systems in place today are inefficient and expensive, frequently due to human error.

The claims industry is lethargic and inefficient by design, yielding in reduced customer retention. Customer inconvenience is the legacy of the claims processing industry. Redundant paper flow results in long lead times for both the Insured and the Insurer. Human error creates inaccuracies that effect both the Insured and the Insurer. The existing claims systems and processes place the consumer in an adversarial role as the restoration profit is the Insurer's expense.

Most conventional claims processes may include communications and decision-making by multiple human elements. For example, while every claim is different, an exemplary process may include the initial filing of an insurance claim over the phone with the insurer hotline, online at the insurer website, or in person at the insurer brick and mortar site. The process may next include either the taking of the automobile to a brick and mortar location to get an estimate on the damage or some insurers offer the option of scheduling for a claims adjuster to come out to the automobile location. Alternatively, some insurers offer the option of repairing through a partnered, local repair shop, for which the repair shop will be reimbursed by the insurer. The claims adjuster will make a recommendation for repairs and costs based upon damages perceived by the naked eye. The insured either has the option to leave the automobile for repair at the insurer's office or choose their own repair shop, both cases which will require a rental car. This conventional process requires the insurer to jump through multiple hurdles and coordinate various logistics, just to start the claims process.

The above-mentioned approach has shortcomings. More particularly, conventional claims processing is too subject to the whims of individual claim adjusters and places undue burden on the insured.

A need exists, therefore, for an automated, vehicle underwriting, damage assessment, and claims management system.

### SUMMARY

The following disclosure presents concepts for an automated, vehicle underwriting, damage assessment, and claims management system. The disclosed subject matter significantly improves upon prior concepts aimed at automating claims adjustment and processing. It is an object of the present disclosure to address rising costs in the insurance industry by enabling automated claims processing that are more consistent, accurate, and significantly faster. Further, it is an object of the present disclosure to yield greater process efficiency throughout an automobile life cycle and to reduce insurers' cost of human capital.

One aspect of the present disclosure is an automated drive-thru claims center. The present disclosure teaches an apparatus for near real-time claims processing by providing a portable, self-contained insurance underwriting and claims management system.

Another aspect of the present disclosure teaches a system for detecting automobile damage by capturing 3D laser images of an automobile and comparing it to a 3D laser image of a brand new version (factory manufacture specifications, with no after-market modifications) of the same vehicle.

Yet another aspect of the present disclose is a system for post-collision automobile damage assessment by identifying damaged components, calculating damage intensity, and determining damage estimates.

Another aspect of the present disclosure is a 3D expert-system that becomes intuitive by reanalyzing each data set with sophisticated data mining.

Yet another aspect of the present disclosure is a post-repair assessment of automobile repair quality.

Another aspect of the present disclosure is claims administering and the triggering of repairer and Business-To-Business (B2B) supply chains.

Yet another aspect of the present disclosure is a total-loss management system for automobile parts.

Another aspect of the present disclosure is to increase underwriting accuracy and minimize both fraud and legitimate claim expenses by removing human errors, duplication and omissions.

Yet another aspect of the present disclosure is reducing human capital expenses by replacement with accurate expert systems which will standardize industry best practices and procedures, leading to increased customer retention.

Another aspect of the present is a mobile platform for 3D accident scene recordation and reconstruction.

Yet another aspect of the present disclosure is the mathematical computation of automobile component damage utilizing materials science and automobile component's mechanical properties.

Another aspect of the present disclosure is the determination of automobile internal damage by assessing automobile exterior deformation.

Yet another aspect of the present disclosure is augmented reality automobile repair and re-assembly.

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with ordinary skill in the art upon examination of the following FIGURES and detailed description. It is intended that all such additional systems, methods, features and advantages included within this description be within the scope of the accompanying claims.

### BRIEF DESCRIPTIONS OF THE DRAWINGS

The features, nature, and advantages of the disclosed subject matter may become more apparent from the detailed description set forth below when taken in conjunction with the drawings, in which like reference numerals indicate like features and wherein:

FIG. 1 is a block diagram of an information system in which collision data is collected at the birth of an accident at the accident site.

FIG. 2 is a block diagram of a delivery system or transporting the insured from the accident site.

FIG. 3 is a block diagram of a delivery system providing increased convenience to the insured by delivering the Insured's repaired automobile and retrieving a rental or loaner automobile.

FIG. 4 is a block diagram of an alternative embodiment employing a claims wizard.

FIG. 5 is a block diagram of a laser mapping system and method for mapping the surface of the damaged automobile soon after the accident.

FIG. 6 is a block diagram illustrating a central-repair facility method.

FIG. 7 is a block diagram illustrating the insured's automobile equipped with a mobile data collection system.

FIG. 8 is a block diagram of an auction system illustrating posting accident information via the communications network for purposes of sale and/or auctioning for parts and services necessary for repair.

FIG. 9 is a simplified block diagram of a parts procurement system implemented according to an embodiment of the present invention.

FIG. 10A depicts an isometric view of an exemplary automated claims processing unit implemented according to an embodiment of the present disclosure.

FIG. 10B illustrates a straight-on, inside view of an exemplary automated claims processing unit implemented according to an embodiment of the present disclosure.

FIG. 11 depicts a see through view into a drive-thru claims center, with vertical laser sources.

FIG. 12 depicts a close-up image of a computer system as placed upon a door according to an embodiment of the present disclosure.

FIG. 13 depicts a wire-frame scan of an automobile as scanned by the present disclosure and indicates damage status of automobile components.

FIG. 14 depicts a wire-frame scan, including interior components, in greater detail.

### DETAILED DESCRIPTION

The following description is not to be taken in a limiting sense, but is made for the purpose of describing the general principles of the present disclosure. The scope of the present disclosure should be determined with reference to the claims. Exemplary embodiments of the present disclosure are illustrated in the drawings, like numbers being used to refer to like and corresponding parts of the various drawings.

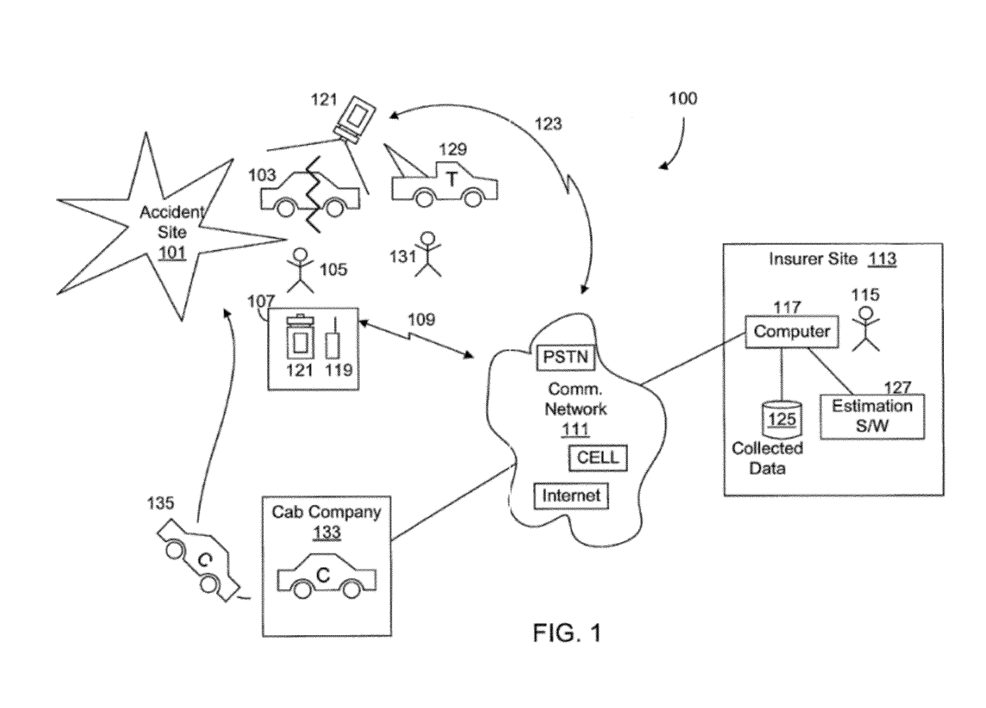

FIG. 1 is a block diagram of an Information System 100 in which collision data is collected at the birth of an accident at the accident site 101. The term “birth” refers to the moment an auto collision occurs and before the traditional insurance industry definition of the collision repair process. An automobile 103 being driven by or otherwise associated with an insured person or the “insured” 105 is in an automobile accident at accident site 101. In one embodiment, the collision is reported by anyone using any of numerous wireless devices 107 via wireless communications 109 to an insurer site 113 via a communication network 111. The communication network 111 incorporates or otherwise encompasses many different types of electronic communication networks. The electronic communication networks include, for example, various telephone networks such as the Public Switched Telephone Network (PSTN) wireless communications and associated devices for enabling communications by cellular telephones and the like (CELL). The electronic communication networks also includes any computer communications networks, such as local area networks (LAN) or wide area networks (WAN) and further encompasses interconnected networks such as comprises the Internet including the Internet backbone and other networks that enable global computer communications.

The insured 105 or any other on-site personnel (at the accident site 101) reports the accident. In one embodiment for example the insured 105 includes a cell phone 119 or the like and places a wireless call to a claims agent 115 at the insurer site 113. Other on site personnel may include police or emergency medical services (EMS) personnel or the like depending upon the needs at the time of the accident. The call using the cell phone 119 is made to the claims agent 115 who then coordinates additional communications, such as to the police or medical personnel, etc. The claims agent 115 may also call a cab company 133 to dispatch a taxi 135 to the accident site 101.

In one embodiment, he insured 105 carries with him or with the automobile 103 a personal digital assistant (PDA) device 121 or the like which is equipped with wireless communications to establish the call or communication to the claims agent 115. The PDA device 121 is further equipped with electronic data capture equipment, such as a digital camera or the like, for retrieving and recording accident information. For example, the PDA device 121 includes a built-in or attachable camera, such as a digital camera. A separate digital camera may be utilized as well, although it is desired to combine the data capture equipment with wireless communications. An on-site person, such as the insured 105, takes one or more pictures of the damaged automobile 103 at the accident site 101. The PDA device 121 may further be used to take a picture of a vehicle identification number (VIN) of the damaged automobile 103. In one embodiment, the PDA device 121 may include or otherwise scan device to scan the VIN if in bar code format. The PDA device 121 may also be used to record other collision information at the accident site 101, such as damage to any other automobiles involved in the accident. Further, the PDA device 121 may be utilized to collect other data such as pictures of any person or persons involved in the accident and any injuries sustained. The PDA device 121 may further be used to collect data such as digital pictures or the like of the accident site 101, such as the scene of the accident and the concomitant environment conditions such as the weather, location, amount of traffic, type of traffic, etc. All such accident information may be used to assess the cause of the accident, damage to automobiles or other vehicles involved in the accident, damage to any other property involved in the accident, and any injuries sustained in the accident.

The data collection equipment combined with wireless communications of the PDA device 121 provides a convenient system for data collection and transfer, particularly associated with assessment and repair of the damaged automobile 103. In particular, the digital pictures and other data is wirelessly transmitted as indicated by a wireless data communication link 123 to a computer system 117 at the insurer site 113 coupled to the communication network 111. Thus, the accident data is collected at the accident site 101 and wirelessly transmitted to the insurer site 113 at the birth of the accident. In this manner, the claims agent 115 need not be involved at the accident site 101. Further, the insured 105 need not be involved in transporting the damaged automobile 103 to the insurer site 113 or any affiliated location in order to collect the damage information, as typically done in the traditional insurance industry model. This removes the claims agent 115 from the field for collecting the data associated with damaged automobile 103, which is ultimately used to identify the claims amount to be paid to the insured 105.

The accident information collected at the accident site 101, via the PDA device 121 or the like, is wireless transferred to the insurer site 113 to the computer 117 and stored in a data storage device 125 coupled to the computer 117. In one embodiment, the claims agent 115 may make a preliminary estimation of the damage to the automobile 103, or may determine that the damaged automobile 103 is totaled and not repairable. In either case, the claims agent 115 uses the accident information to determine a preliminary claims estimate for the insured 105. In one embodiment, the computer 117 may further be equipped with an estimation software 127, or the like, operated by the claims agent 115 to assist or otherwise facilitate review and assessment of the data to identify a claims estimate or the damage to the automobile 103. The estimation amount may be transmitted wirelessly, such as via data communication link 123, to the PDA device 121 and displayed to the insured 105 soon after the accident. Alternatively, the claims agent 115 may simply establish a claims number and wirelessly transmit the claim information to the insured 105 via the PDA device 121.

The claims agent 115 may further identify a local affiliated tow truck establishment and contact the establishment to send a tow truck 129 to the accident site 101. The tow truck 129 is primarily employed to retrieve the damaged automobile 103 from the accident site 101. A tow truck driver 131 is thus brought to the accident site 101 and is considered another one of the on-site personnel. In one embodiment, the PDA device 121 or another PDA device similar to it is brought by the tow truck driver 131 for collecting the data in a similar manner. Thus, any of the on-site personnel, including the insured 105 and/or the tow truck driver 131, may be employed to utilize the PDA device 121 to collect damaged data and accident information. Thus, the insured 105 may be equipped with the PDA device 121, or the truck driver 131 may be equipped with the PDA device 121, or both may be so equipped for redundancy to insure that the data is collected at the accident site 101. Of course, other on-site personnel may be employed to collect the data, such as policeman, an ambulance driver or paramedic, etc., although such on-site personnel typically have other duties and are unlikely candidates for data collection purposes. Any of the on-site personnel such as the insured 105, the tow truck driver 131, or police, ambulance driver or paramedic may be employed to call the cab company 133 to dispatch the taxi 135 in order to retrieve the insured 105 from the accident site 101 and deliver the insured 105 to any convenient location, such as an automobile rental agency. Alternatively, as previously described, the claims agent 115 calls the cab company 133. It is noted that the tow truck 129 may be employed to deliver the insured 105 to the cab company 133 or to an automobile rental agency. These scenarios for delivery of the insured 105 assumes that the insured 105 is not significantly injured and ported to a hospital via ambulance.

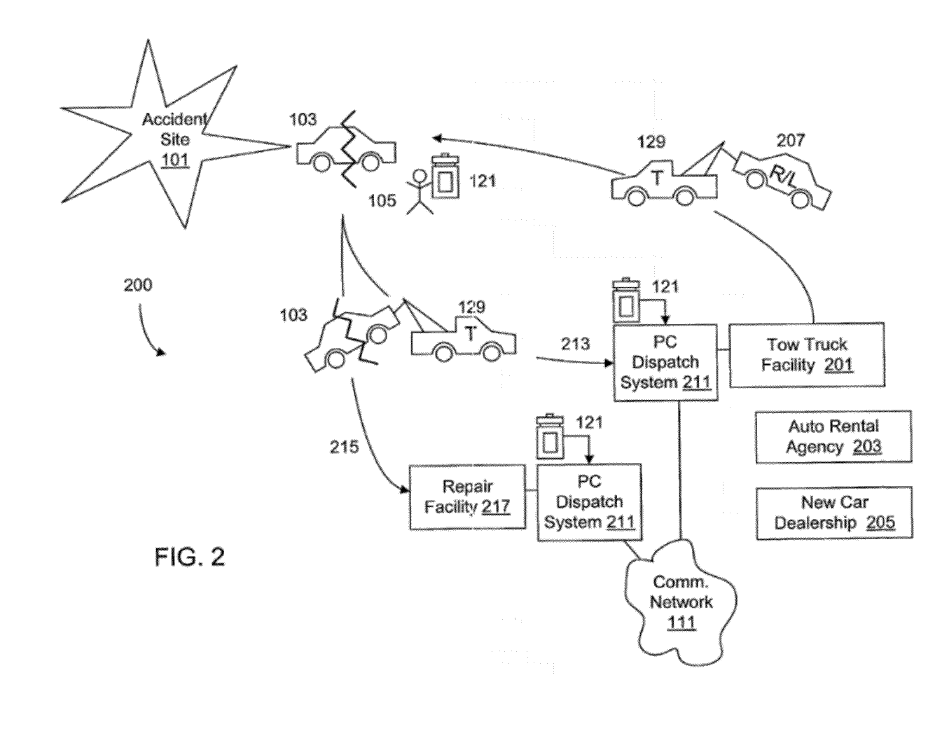

FIG. 2 is a block diagram of a delivery system 200 for transporting the insured 105 from the accident site. In this case, the two truck facility 201 is informed of the location of the accident site in order to retrieve the damaged automobile 103. In this case, the dispatched tow truck 129 picks up a rental or loan (R/L) automobile 207 from either an automobile rental agency 203 or a new car dealership 205. In particular, the R/L automobile 207 is a rental car (R) retrieved from the automobile rental agency 203, or a loan car (L) retrieved from a new car dealership 205 which may be associated with a particular automobile manufacturer. Thus, the tow truck 129 retrieves and R/L automobile 207 and delivers the R/L automobile 207 to the accident site 101 for use by the insured 105. In this manner, the insured 105 is not stranded at the accident site 101 and convenience is maximized. The tow truck 129 then retrieves and delivers the damaged automobile 103 either to the tow truck facility 201 via route 213 or to a repair facility 217 via route 215. In this manner, the tow truck 129 serves the dual purpose of delivering a temporary automobile to the insured 105 and retrieving and delivering the damaged automobile 103 to the appropriate location. The delivery to the repair facility 217 is most desirable if the repair facility 217 is predetermined or otherwise identified, such as by the claims agent 115. Otherwise, the tow truck 129 delivers the damaged automobile 103 to the tow truck facility 201 for later delivery to the repair facility 217.

As described previously, the PDA device 121 is utilized to collect damage and accident information at the accident site 101 and this information is wirelessly communicated to the insurer site 113. If the PDA device 121 is not equipped with wireless communications, or if the wireless communications are otherwise unavailable or inoperative, the PDA device 121 with the collected data may remain with the damaged automobile 103 and be delivered to the tow truck facility 201 and/or the repair facility 217. The tow truck facility 201 and/or the repair facility 217 may be equipped with a (PC) dispatch system 211 or the like, that includes an appropriate interface, such as a cable, a docking unit, a cradle unit, tec., for coupling to and retrieving the collected data from the PDA device 121. The PC dispatch system 211 is coupled to the communication network 111 for transmitting the data to the insurer site 113 via the PC dispatch system 211. In this manner, the data is collected at the accident site 101 and delivered soon thereafter upon delivery of the damaged automobile 103.

The automobile rental agency 203 may be affiliated with the insurer of the insured 105. The new car dealership 205 may also be affiliated with the insurer such as through contract or the like and delivers a loan car temporarily to the insured 105 for various purposes. For example, the new car dealership 205 may utilize the opportunity to market a new car to the insured 105 since the damaged automobile 103 may be considered totaled and longer usable as originally intended. Alternatively, the car dealership 205 may be associated with a manufacturer that also manufactured the damaged automobile 103 in an attempt to have the insured 105 purchase a new car from the same manufacturer. Alternatively, the manufacturer may be a competing manufacturer of the manufacturer that manufactured the damaged automobile 103 and may potentially obtain new business.

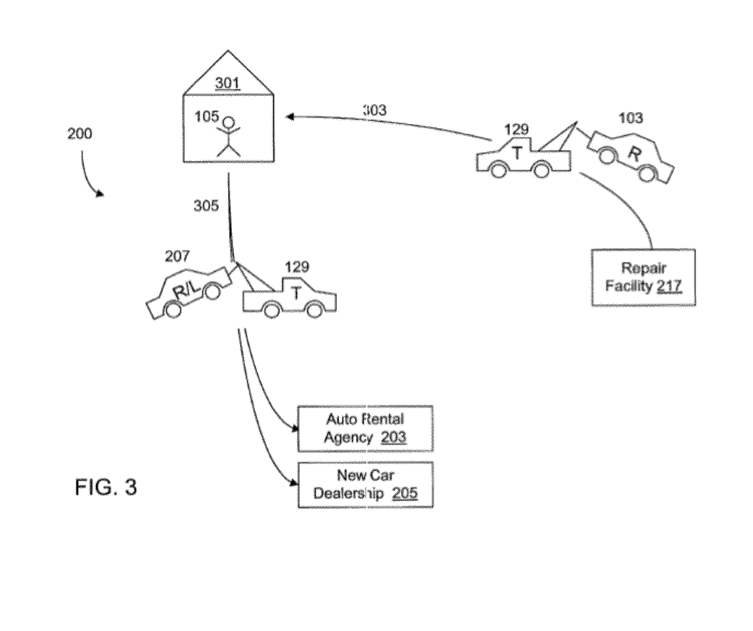

FIG. 3 is a block diagram of a delivery system 300 providing increased convenience to the insured 105 by delivering the Insured's repaired automobile 103 and retrieving the R/L automobile 207. After the damaged automobile 103 is repaired, as indicated by the letter “R”, the tow truck 129 or similar tow truck retrieves and delivers the repaired automobile 103 indicated by arrow 303 to the insured 105 at a convenient location or at a mutually acceptable location such as the insured's home 301. It is noted that such delivery may be of ultimate convenience to the insured 105 and may be at any convenient location that the insured 105 happens to be at when the repair automobile 103 is ready for delivery. The tow truck 129 then retrieves the R/L automobile 207 and returns t to its original location, such as the automobile rental agency 203 or the new car dealership 205 as previously described. In this manner, the insured 105 need not be involved in the traditional insurance loop, such as having to return the rental car and retrieve the repaired automobile 103.

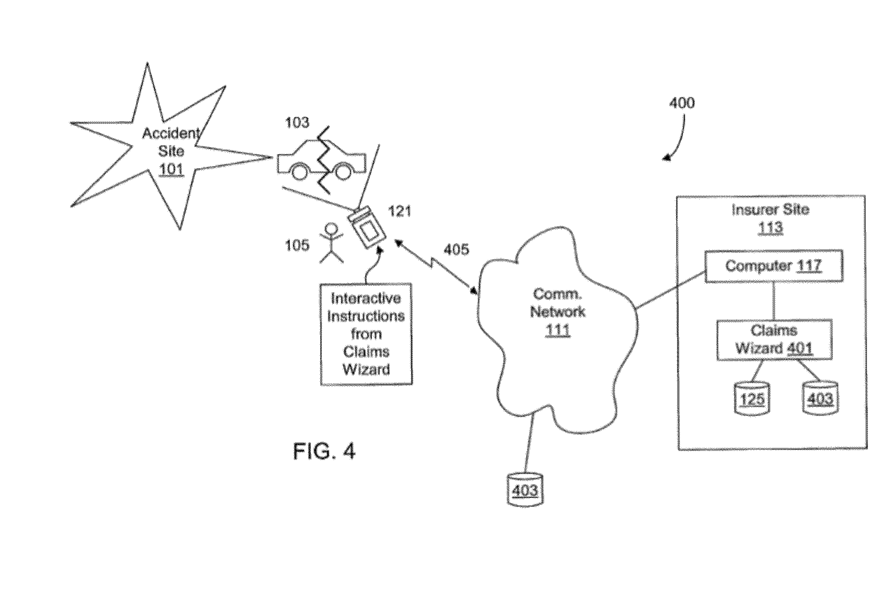

FIG. 4 is a block diagram of an alternative embodiment employing a claims wizard 401. In this embodiment, the wireless communications with the PDA device 121 as indicated by wireless communications link 405 is interactive for more efficient or otherwise more informative data collection. In this case, the computer system 117 is equipped with a claims wizard 401, which interactively cooperates with the PDA device 121 to communicate to the insured 105 regarding particular data collection parameters. The claims wizard 401 also stores the damage and accident information in the data storage device 125. Further, the claims wizard 401 in one embodiment is informed of the type of vehicle such as identified by the insured 105 or through the VIN collected at the automobile accident site 101 from the damaged automobile 103 and determines what particular data needs to be collected. For example, the claims wizard 401 retrieves initial data, such as an initial digital picture or the like from the PDA device 121, and accesses a local master database 403. The master database 403 identifies similar-type accidents or otherwise similar-type automobiles and identifies any potential additional information that should be collected. In this manner, the claims wizard 401 operates as an expert system that stores past and potentially relevant information that may be applicable or otherwise relevant to the particular accident involved the damaged vehicle 103.

During operation, the claims wizard 401 transmits instructions to the operator of the PDA device 121, such as any on-site personnel including the insured 105, to collect any further information regarding the accident. For example, the claims wizard 401 may instruct the operator of the PDA device 121 to take digital pictures of certain parts of the automobile 103, such as particular angles and views, including the opposite side of the primary damage portion or the undercarriage of the damaged automobile 103, or any other data that may be considered pertinent to damage assessment. The information collected on the damaged automobile 103 at the accident site 101 is then stored in the data storage device 125 in a similar manner as previously describe. Furthermore, the data may be incorporated into the master database 403 and used by the claims wizard 401 in subsequent accidents. In this manner, it is appreciated that the claims wizard 401 is an expert system, such as using artificial intelligence or the like, to continuously learn and adapt in order to improve and streamline the data collection process at accident sites such as the accident site 101. The data is collected in a master database 403 which may be maintained local at the insurer site 113. Alternatively, or in addition, the master database 403 may be located remotely relative to the insurer site 113 and accessible via the communication network 111 such as the Internet or the like.

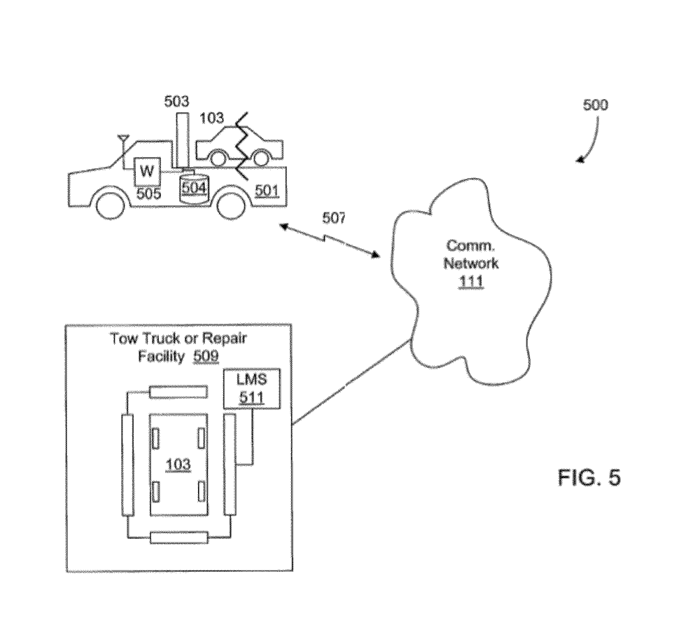

FIG. 5 is a block diagram of a laser mapping system and method 500 for mapping the surface of the damaged automobile 103 soon after the accident. In one embodiment, a tow truck is equipped with a laser mapping system (LMS) 503 which retrieves information from the damaged automobile 103 once mounted onto the tow truck 501 and during delivery thereof. The tow truck 501 may be a flatbed type tow truck for conveniently mounting and positioning the damaged automobile 103. The laser mapping system 503 is positioned to use laser-mapping technology to obtain more accurate damage information from the damaged automobile 103. The information may be stored on the tow truck 501 such as utilizing a local storage device 504. Alternatively, the data collected by the laser mapping system 503 is wirelessly communicated by a wireless communications device 505 on the tow truck 501 that wirelessly communicates 507 the damage information via the communication network 111. Again, the data is delivered to the insurer site 113.

In an alternative embodiment, the tow truck or repair facility 509 representing either the tow truck facility 201 or the repair facility 217 may be equipped with a laser mapping system 511. The damaged automobile 103 is positioned for data collection by the laser mapping system 511 and the data is either stored locally or communicated to the computer system 117 of the insurer site 113 via the communication network 111 in a similar manner as previously described.

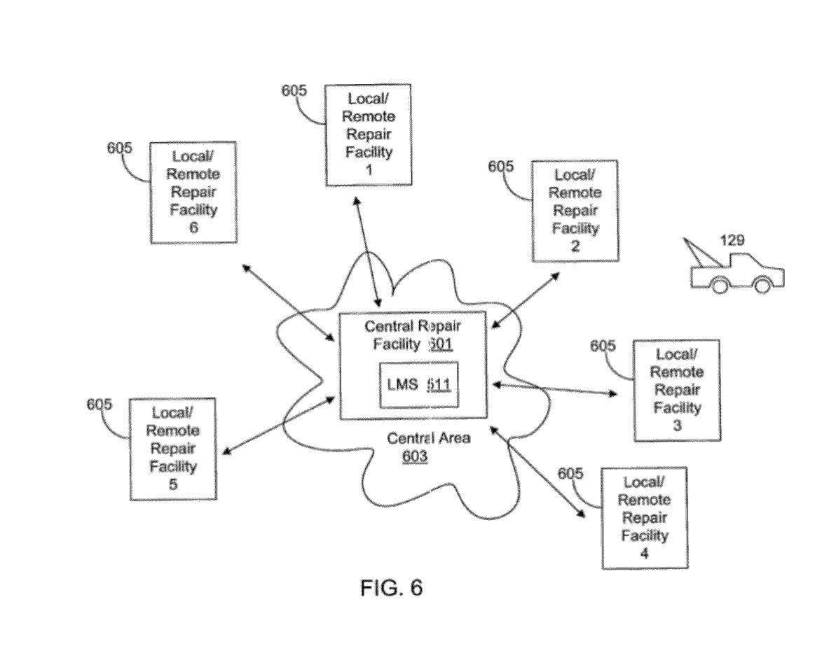

FIG. 6 is a block diagram illustrating a central-repair facility method. It is noted that the laser mapping system 511 may be relatively sophisticated and expensive and may not be affordable by many repair facilities that may be utilized to repair the damage to automobile 103. In this case, a central repair facility 601 is equipped with the laser mapping system 511 at a central area 603. The central area 603 represents any centralized location, such as a city, county, town, etc. The immediate area or surrounding area may include one or more local or remote repair facilities 605 that may perform some or all of the repairs to the damaged automobile 103. As shown, several local or remote repair facility 605 are shown, individually numbered 1 through 6, although any number, more or less, is contemplated.

The damaged automobile 103 may be analyzed and completely repaired at the central repair facility 601. However, the central repair facility 601 may not have the capacity to handle the demand or the number of damaged cars at any given time so that some or all of the repairs are handled by any one or more of the local or remote repair facility 605. Rather than making the insured 105 wait on additional amount of time for the repaired automobile 103, it is contemplated that the tow truck 129 or the like is utilized to transport the damaged automobile 103 to any of the local or remote repair facilities 605 to expedite the repair process. The local or remote repair facility 605 represent any type of facility such as body shops, paint shops, garages, etc., and includes any type of repair facility or services necessary to repair the damaged automobile 103.

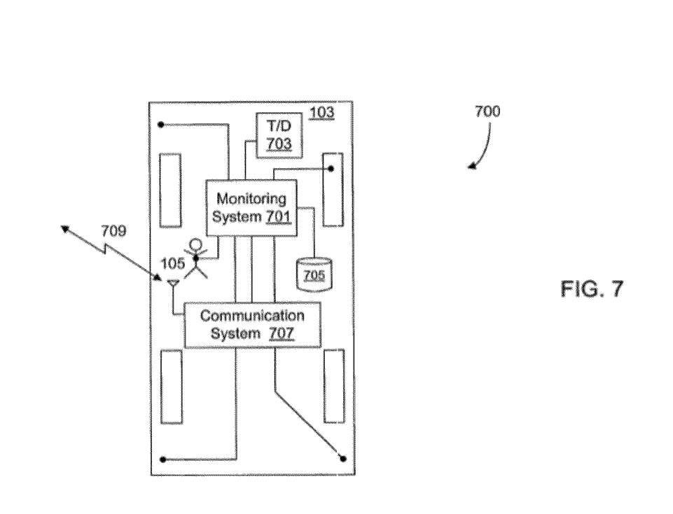

FIG. 7 is a block diagram illustrating the automobile 103 equipped with a mobile data collection system 700. The automobile 103 is equipped with a monitoring system 701 coupled to a plurality of sensors that detect any information associated with the condition and operation of the automobile 103. The data is transferred to a data storage device 705 associated with use and operation of the automobile 103. The monitoring system 701 collects any type of data and information such as ambient conditions including weather, location and traffic, as well as conditions of the damaged automobile 103. The condition of the automobile 103 may include any previous damage, any disrepair or any condition such as the engine, tire, brakes or any other operating systems of the automobile 103 including conditions or lack of repair. Furthermore, the monitoring system 701 monitors the controls of the automobile 103 used by a driver such as the insured 105 during operation. Certain information such as the engine or brake systems needing repair may be collected and stored until the condition is changed. Other information such as the controls of the automobile 103 may be monitored on a continuous basis where only the latest amount data such as the last 24 hours of operation are monitored.

In one embodiment, it is contemplated that the monitoring system 701 operates in a similar manner as a black box mounted in aircraft that are utilized to collect data and information associated with an accident. In this manner, the monitoring system 701 detects and collects any and all accident information associated with the accident, where the data may be utilized in any one of several manners. In one embodiment, the data is simply used to assess the damage to the automobile 103. In other embodiments, the data may be utilized to assess actions taken by the insured 105 or others that may have caused the accident. In any case, the accident may be reconstructed to a certain level.

The monitoring system 701 may be further coupled to a communication system 707 for communicating collected information via a wireless communications link 709 such as through the communications network 111. The communication system 707 may be in fact the PDA device 121 cradled or docketed such as in the glove box or the like. Alternatively, the communication system 707 may be integrated into the automobile 103, such as the On-Star system or the like. The communication system 707 may be utilized independently and in lieu of the monitoring system 701 to report the accident and collect information, or utilize in conjunction with the monitoring system 701 to transmit collision damage and accident information to the insurer site 113.

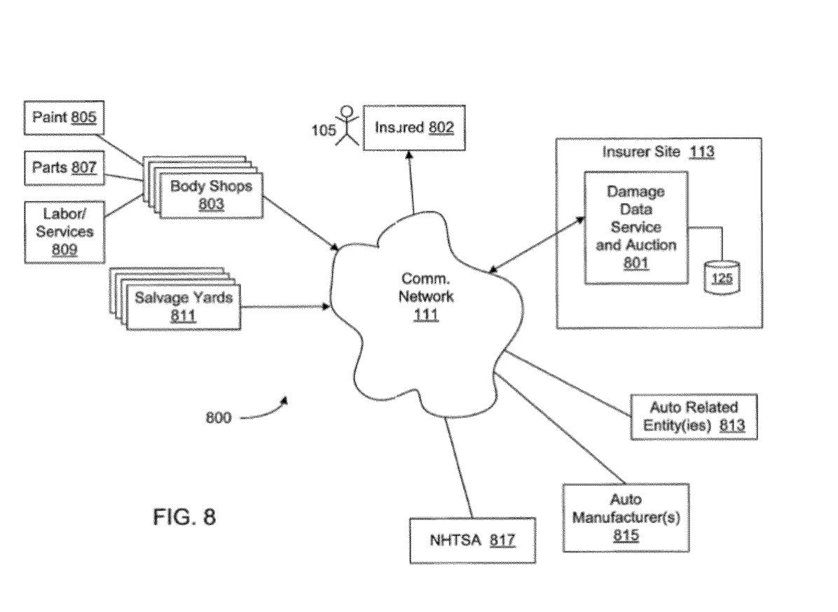

FIG. 8 is a block diagram of an auction system 800 illustrating posting accident information via the communications network 111 for purposes of sale and/or auctioning for parts and services necessary for repair. In this case, the damage information collected in the data storage device 121 at the insurer site 113 associated with the accident of the damaged automobile 103 is posted in any desired format, such as a web page 801 or the like, via the communication network 111 such as the internet or the like. The insured 105, at a convenient terminal or computer 802 or the like coupled to the communications network 111, is able to review the information associated with the accident, including, for example, a claim number. The damage information of the automobile 103 is also posted to any affiliated source, such as one or more body shops 803, or one or more salvage yards 811. In one embodiment, the data may be posted for free to solicit bids from any body shops 803 and/or salvage yards 811 interested in either repairing the damaged automobile 103 or retrieving it for scrap. It is noted that the body shops 803 are further associated with paint shops 805, parts departments 807 and/or labor and services 809.

In another embodiment, a plurality of body shops 803 and/or salvage yards 811 are affiliated with the insurer and may be notified via e-mail or the like of the accident. The data is posted via the communication network 111 to the affiliated entities, such as the body shops 803 and/or salvage yards 811, which may then submit bids. The insured 105 may monitor any bid(s) submitted by body shops 803 and/or salvage yards 811 and select any one of choice. In the insured industry, it is the responsibility of the insured 105 to select the body shop to repair the damaged automobile 103 or otherwise to sell the damaged automobile 103, such as to a salvage yard or the like. The auction system 800 provides a convenient system for the insured 105 to identify and select a particular body shop 803 or salvage yard 811 to handle the damaged automobile 103. Of course, the insured 105 may optionally choose to select alternative body shops or salvage yards at his or her discretion.

The data and accident information posted by the insurer site 113 may further be of interest to other parties who desire to pay for such information. For example, automobile manufacturers 815 may desire the information for use in improvements to subsequent automobile manufacturer. The National Highway Transportation Safety Association (NHTSA) 817 may further desire to purchase the data to collect aggregate statistics on automobile accidents. Of course, any other auto-related entity 813 may purchase the data for various other reasons.

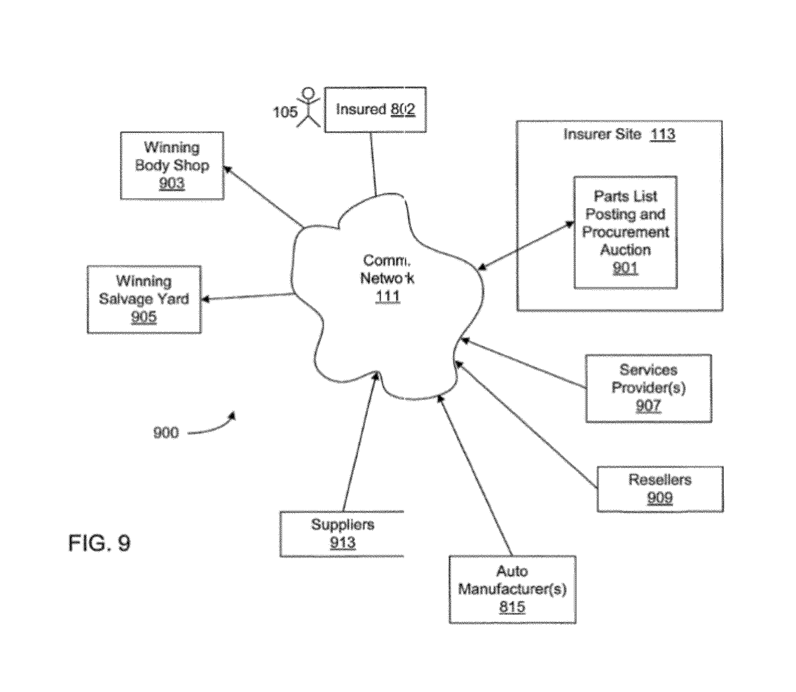

FIG. 9 is a simplified block diagram of a parts procurement system 900 implemented according to an embodiment of the present invention. The insurer site 113 further posts a parts-list posting and procurement auction 901 via the communication network 111 for bid by any parts suppliers 913, automotive manufacturers 911, resellers 909 or other service providers 907. The winning body shop 903, or otherwise the winning salvage yard 905, may review the bids and select parts based on bids by any of the service providers 907, resellers 909, automotive manufacturers 911 or suppliers 913.

Embodiments of the present disclosure may be applied as an individual business application, a third party claims administrator, or more broadly as a technological catalyst for vertical or horizontal industry consolidation.

The present disclose utilizes advanced optical, including, but not limited to utilizing stereo-photogrammetry and high-definition laser scanning to create a comprehensive digital model of the insured automobile 1102 at the inception of coverage, and then again at the damage claim. We leverage this advantage by comparing and processing three-dimensional models in real-time with our expert system software suite, which calculates the necessary repairs, thus creating substantial savings, and adding convenience and transparency to the entire value chain.

One specific application of the present disclosure is at the initial automobile 1102 underwriting process. By capturing the automobile 1102 condition at the birth of the policy and at annual policy renewals, the present disclosure comprehensively documents the insured's automobile 1102 in extremely accurate three-dimensional detail. By comparing this three-dimensional digital model with that of a new ‘stock’ vehicle, the present diclosure's software suite detects and documents pre-existing damage, thereby decreasing fraud and in turn, mitigating loss expense for insurers. Additionally, this comparison yields the detection and documentation of any exterior upgrades, add-ons or aftermarket accessories, which are potential sources of additional insurance revenue, and points of contention at time of claim if left unchecked. The present disclosure creates a far more accurate and precise underwriting component, one with the ability to generate additional revenues as well as to significantly lessen fraud.

A second specific application is a post-collision assessment of the automobile 1102 for determining extent and costs of repairs for damages. The present disclosure creates a three-dimensional model of the now damaged automobile 103 and superimposes it upon the archived model of the insured's undamaged vehicle. The expert system not only detects any surface damage, but also determines the extent of damage beneath the surface. The system includes, but is not limited to, component identification, repair/replace cost analysis, total loss analysis, salvage disposition, claims administration, selection and scheduling of repair provider, parts procurement and logistics. With each claim, data is aggregated and mined, further enhancing analysis and predictive modeling.

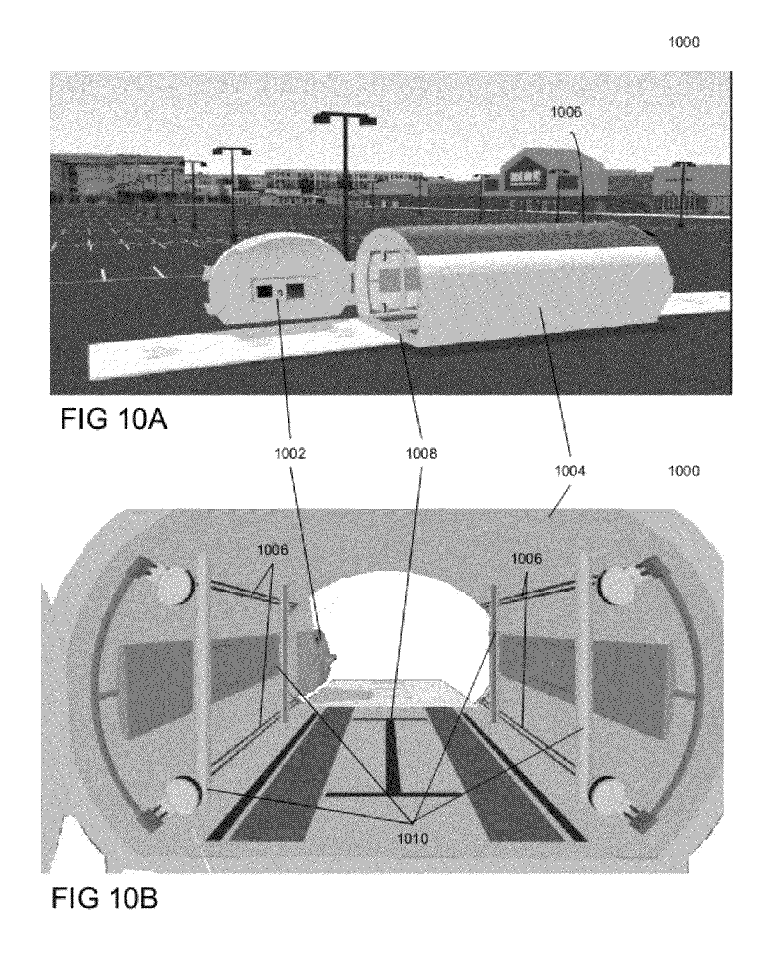

The present disclosure teaches an automated claims process unit, one exemplary embodiment being the drive-thru claims center 1000. An alternative embodiment (not shown) would not include the outer enclosure 1004 that is surrounding the drive-thru claims center 1000. FIG. 10A depicts an isometric view of an exemplary automated claims processing unit implemented according to an embodiment of the present disclosure. FIG. 10B illustrates a straight-on, inside view of an exemplary automated claims processing unit implemented according to an embodiment of the present disclosure. The drive-thru claims center 1000 is capable of provide insurance underwriting and claims management in near real-time. Whereas the conventional insurance claim submittal process may involve multiple contacts to various parties before a claims agent 115 will be able to look at the automobile at the insurer site 113, the drive-thru claims center 1000 does not require an appointment and is capable of examining an automobile for damage, estimating costs for repair, and make payment of insurance claims within five minutes of pulling in. The drive-thru claims center 1000 employs ATM technology in a computer 1002 for immediate payment, settling insurance claim quickly, and with laser accuracy and fairness. Although this embodiment implements computer 1002 in the form of an ATM payment system, various other computing systems may be employed within the scope of the present disclosure.

Due to the drive-thru claims center 1000 portability, the units are available for temporary deployment to severe weather locations, bringing rapid closure to multiple claims, and yielding increased customer convenience, satisfaction and retention. The drive-thru claims center 1000 is fully self-contained and portable to the insurer's customer base, with deployment possible in high density, high-visibility urban and suburban areas. Additionally, highly effective, low cost marketing can be obtained through the creative use of its exterior graphics, extorting the virtues of the first fair, science-driven methodology to attract new customers. Adjacent to the computer 1002 is dedicated advertising space, which may be sold to the repairer community, for example. Customers may purchase ad space or exclusive auction rights for their products or services and include: the towing industry, estimating software companies, assorted service providers, independent claims administrators, emergency medical services, auto (AAA) clubs, GM OnStar notification service, paint and parts manufacturers and suppliers, fleet service companies, auto repair consolidators, rental fleets, personal injury professionals, accident investigators, NHTSA/DOT/auto manufacturers, risk modelers, safety institutes and more.

Integrated with the outer enclosure 1004 is an energy source 1006 for use in powering the claims center 1000, further enabling its stand-alone and portable features. Energy source 1006 is shown as a solar cell panel within FIG. 10A, but may take the form of any other electricity power source, including, but not limited to: batteries, wind energy, gas-powered. Additionally, energy source 1006 does not have to serve as the primary source of power for operating claims center 1000. Claims center 1000 may be directly plugged into a wall outlet for drawing electricity off the grid, with energy source 1006 serving as backup power.

Disposed within enclosure 1004 is a platform 1008 upon which a user will place the automobile 1102 to be scanned. One or more laser sources 1010 may be employed to scan the automobile 1102 surface. The present disclosure teaches one embodiment of the laser source 1010 as a hi-definition laser scanner being a piece of computerized optical hardware that paints a solid object with a laser light thousands of times per second creating a digital model consisting of map points in 3D space. Photogrammetry, a first remote sensing technology, may be employed in which geometric properties about objects are determined from photographic images. Stereo-photogrammetry makes it possible to estimate the three-dimensional coordinates of points on an object, which are determined by measurements made in two or more photographic images taken from different positions. These two technologies provide the data acquisition for a complex database which is then used by the present disclosure's advanced expert-systems to analyze the images and calculate necessary adjustments. High-speed broadband networks and advanced data compression technologies facilitate the transmission of data from mobile capture devices to a central server in an n-tier system. Digital watermarks and advanced encryption techniques allow for a secure environment. Our process utilizes scanners in both static and tow truck mounted dynamic applications to serve the widest variety of configurations and business models. In summary, our technology solutions are based upon stereo-photogrammetry, high-definition laser scanning, expert-systems and wireless high-speed data transmissions.

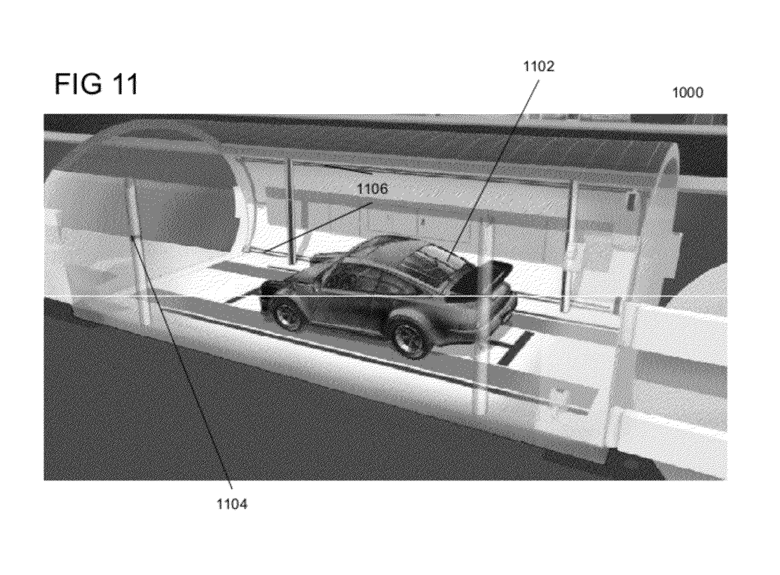

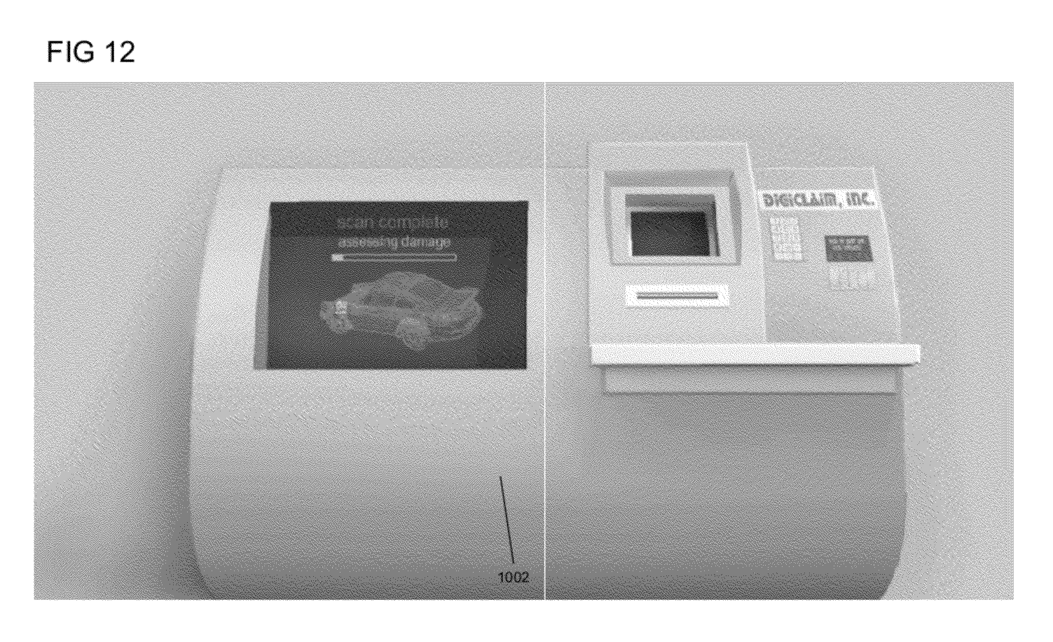

FIG. 11 depicts a see through view into a drive-thru claims center, with vertical laser sources. Alternatively, the laser sources may scan along the automobile 1002 horizontally, moving upon horizontal tracks 1106. The one or more laser sources 1010 will capture and transmit data representing multiple image files of each automobile section scanned to computer 1002, a close-up picture which is shown in FIG. 12. This data transmission may be through wireless connectivity, wired LAN, or any other method of electronic data transmission.

The computer 1002 acts as a three-dimensional expert system via comparing pre- and post-collision images to determine damage intensity. A comprehensive catalog of components is mathematically identified and associated in three-dimensional space for future reference to the anomalies of the vehicle's exterior. Mechanical properties and load capacities are assigned for the various components with material differences. In materials science, the strength of a material is its ability to withstand an applied stress without failure. The applied stress may be tensile, compressive, or shear. Strength of materials is a subject which deals with loads, deformations and the forces acting on the material. A load applied to a mechanical member will induce internal forces within the member called stresses. The stresses acting on the material cause deformation of the material. Deformation of the material is called strain, while the intensity of the internal forces are called stress. The strength of any material relies on three different type of analytical method: strength, stiffness and stability, where strength refers to the load carrying capacity, stiffness refers to the deformation or elongation, and stability refers to the ability to maintain its initial configuration. Material yield strength refers to the point on the engineering stress-strain curve (as opposed to true stress-strain curve) beyond which the material experiences deformations that will not be completely reversed upon removal of the loading. The ultimate strength refers to the point on the engineering stress-strain curve corresponding to the stress that produces fracture. Various methods can be employed to predict the response of a structure under loading and its susceptibility to various failure modes may take into account various properties of the materials other than material (yield or ultimate) strength. These methods are employed in conjunction with scanned image data at the computer 1002 to determine whether a particular surface deformation due to an accident is merely a surface defect that may be repaired (e.g., ding) or whether the deformation was caused by such a force that underlying components or structural integrity of the vehicle has been compromised. If the threshold for replacing was not activated, the system then draws parameters with our suppliers and quantifies the dollars (labor) for the given deviation. Further, internal damage can be determined from the deformation of the exterior of the vehicle, eventually eliminating costly and time consuming supplemental inspections.

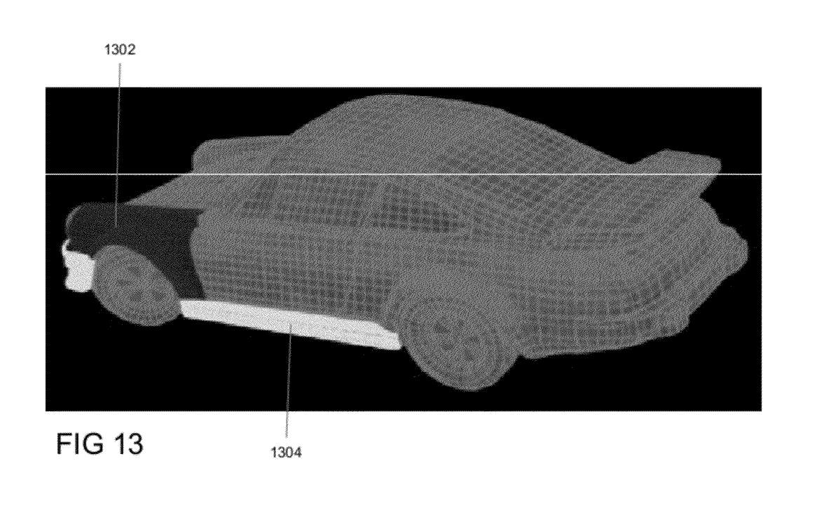

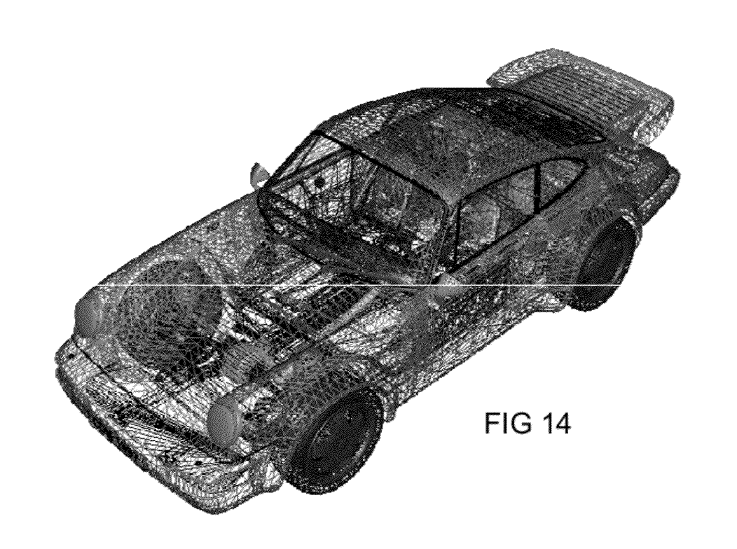

The computer 1002, as shown in FIG. 12, will automatically engage in these calculations upon finishing laser scanning of the automobile 1102. The computer 1002 will then subsequently identify and defines, with color-coding, all damaged components with either ‘certainty’ or ‘probability’ markers. An exemplary output is depicted in FIG. 13, where the laser scanner has created a wire image of an automobile and indicated with a red coloring 1302 that the front left side of the automobile has been dented beyond repair. Yellow coloring area 1304 indicates that the frame and bumper is inconsistent with factory specifications, possibly due to improper installation, repair, or the use of OEM components. A more detailed wire depiction of the system output is depicted in FIG. 14.

Further, the present disclosure enables the determination of damage estimates by correlating this damage status with replacement parts and repair labor costs. The present disclosure also enables the system to automatically administer claims, pay on the spot, and triggers repairer and B2B supply chains. This three-dimensional computer, expert-system, becomes intuitive by reanalyzing each data set with sophisticated data mining.

The computer 1002 is also capable of administering procurement of products and supplies by integrating the B2B supply chain of new O.E.M., Refurbished O.E.M. or L.K.Q. aftermarket repair and replacement parts. The computer 1002 further enables virtualization of the recovery of ‘total-loss’ vehicle assets. Within the insurance industry, ‘total-loss’ refers to vehicles that have sustained such damage that the insurance amount to be paid out for repairs to the insured exceeds the value of a replacement car. Thus, it is more economical for the insured to pay the cost for a replacement vehicle. However, these ‘total-loss’ vehicles often have components that are still viable as replacement parts for another vehicle. Rather than collecting pennies on the dollar to divest such an asset, the insurer is able to reduce product ambiguity and therefore increase vehicle value. By scanning, identifying, and defining all components with color-coding regarding damage status, the system is able to further identify all remaining undamaged components for use by other repairers, unlocking value for the whole value chain. This virtualization of the process shortens cycle times, decreases storage and enables sale of ‘total-loss’ assets.

An alternative embodiment (not shown) involves placing sensors within the platform 1008 for purposes of scanning for automobile 1102 frame alignment both during and after automobile repair processes to assess repair quality. Frame rails, as well as door and panel fitments, can be certified accurately installed, by re-scanning the automobile 1102 after completion of repair. An estimated 80-85% of all repair facilities 217 do not possess modern frame machines to determine whether frame repairs are conducted properly. The ones that do are employing sound based, as opposed to optical-based systems that are susceptible to sound disturbances. Temperature changes or any higher than normal audible decibel range sounds will interfere with accuracy of these optical based systems. Thus, it would be preferable to install a laser-based alignment system as disclosed by the current disclosure.

Another embodiment taught by the present disclosure is application of the system within accident reconstruction parameters. An application includes a mobile platform wherein laser scanners are integrated onto tow trucks 129, and these tow trucks 129 as often first-responders on the accident scene often have an unique opportunity to accurately capture an accident scene. After scanning the vehicle in the collision example above we perform a 360-degree capture of the collision environment (e.g., the crash site and road area) creating a three-dimensional model, which includes real-time forensic data. This three-dimensional model enables us to recreate realistic collision or accident environments with precision and accuracy. Aided by complex analytics and a sophisticated user interface, accident reconstruction can be leveraged and may be especially useful for accident reconstruction in jury cases, such as personal injury litigation.

Although the present disclosure is directed specifically towards the claims process of the automobile insurance industry, the present invention is not so limited and is applicable to any industry where an inspection, comparison, verification or observation process occurs. The present invention facilitates economies in other industries, such as including, but not limited to, civil engineering, public works, construction, fraud prevention, security, traffic enforcement, shipping, inventory control, etc. The present invention also facilitates the consolidation of such industries, but again, is not limited to the industries described herein.

The foregoing description of embodiments is provided to enable a person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A system for performing three-dimensional forms condition operations, comprising:
a platform for placing a three-dimensional form upon;
one or more imaging sensors disposed around said platform, wherein said one or more imaging sensors are comprised of one or more laser scanners for producing one or more; and
a computer, said computer comprising a storage medium, a processor, a communications medium, and a display, said computer executing the following steps:
sending instructions to one or more of said imaging sensors to begin scanning said three-dimensional form, said instructions transmitted via said communications medium;
receiving a set of three-dimensional image scan data, said set of three-dimensional image scan data associated with said three-dimensional form and contains characteristics of said three-dimensional form; and
storing said set of three-dimensional image scan data on said storage medium.

2. The system of claim 1, wherein said platform is generally enclosed by an outer enclosure.

3. The system of claim 1, wherein said processor further executes a set of instructions for calculating differences between said set of three-dimensional image scan data and a pre-populated database.

4. The system of claim 3, wherein said processor further executes a set of instructions for visually presenting differences between said set of three-dimensional image scan data and a pre-populated database.

5. The system of claim 1, wherein said one or more imaging sensors is further comprised of one or more multi-mode sensors.

6. The system of claim 1, wherein said three-dimensional form is an automobile.

7. The system of claim 1, wherein said communications medium is a wireless connection.

8. The system of claim 1, wherein said one or more imaging sensors is mounted on a tow truck.

9. A method for performing three-dimensional forms condition operations, comprising the steps of:
sending instructions to one or more imaging sensors to begin scanning a three-dimensional form, said instructions transmitted via a communications medium;
receiving a set of three-dimensional image scan data, said set of three-dimensional image scan data associated with said three-dimensional form and contains characteristics of said three-dimensional form;
storing said set of three-dimensional image scan data on a storage medium; and
calculating differences between said set of three-dimensional image scan data and a pre-populated database.

10. The method of claim 9, further comprising the step of scanning an automobile collision environment.

11. The method of claim 9, further comprising the step of relating said differences between said set of three-dimensional image scan data and a pre-populated database to a set of mechanical properties for the material said three-dimensional form is comprised of.

12. The method of claim 9, further comprising the step of determining internal damage of said three-dimensional form by correlating with external damage.

13. The method of claim 9, wherein said set of mechanical properties is comprised of materials science strength of materials.

14. The method of claim 9, further comprising the step of identifying damage status of the components of said three-dimensional form.

15. The method of claim 14, further comprising the step of determining the severity of damage of said components.

16. The method of claim 14, further comprising the step of reconstructing automobile collisions.

17. The method of claim 14, further comprising the step of measuring automobile car frame alignment.

18. The method of claim 14, further comprising the step of establishing a database of three-dimensional form data sets.

19. The method of claim 14, further comprising the step of establishing a database of three-dimensional form components.

20. The method of claim 18, further comprising the step of utilizing said database of three-dimensional form data sets for engaging in augmented reality imaging.
